(19) United States
(12) Patent Application Publication
(10) Pub. No.: US 2007/0133408 A1
(43) Pub. Date: Jun. 14, 2007

(54) Apparatus and method for authenticating traffic using packet header information

(75) Inventors: No Ik Park, Seoul (KR); Soon Seok Lee, Daejeon-city (KR); Young Sun Kim, Daejeon-city (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/635,554

(22) Filed: Dec. 8, 2006

(30) Foreign Application Priority Data
Dec. 8, 2005 (KR) 10-2005-0120057
Sep. 29, 2006 (KR) 10-2006-0096632

(51) Int. Cl. H04L 12/26

(52) U.S. Cl. 370/230; 370/389

(57) ABSTRACT

Provided is a traffic authentication apparatus using information on a header of a packet for traffic authentication. The apparatus includes a call admission control agent receiving a call admission request from a calling terminal; a network controller determining whether to approve the call admission request received by the call admission control agent and obtaining call information from the call admission request; and a networking unit which, when the networking unit receives traffic from the calling terminal, compares information on the header of a packet of the traffic with the call information received from the network controller and authenticates the traffic.

This application claims the priority of Korean Patent Application No. 10-2005-0120057, filed on Dec. 8, 2005 and Korean Patent Application No. 10-2006-0096632, filed on Sep. 29, 2006, in the Korean Intellectual Property Office, the disclosures of which are incorporated herein in their entirety by reference.

### BACKGROUND OF THE INVENTION

1. Field of the Invention

The present invention relates to an apparatus and method for authenticating traffic using packet header information, and more particularly to, an apparatus and method for authenticating traffic by comparing call information obtained in a call admission control process with information on the header of a packet flowing into the network.

2. Description of the Related Art

Premium services with guaranteed quality are provided in currently emerging, so-called next generation networks (NGN). Fares for premium services are charged based on QoS, time taken in using the service, amount of the service used, number of services used, etc. For example, the fare for a VoIP service is charged based on an SLA, number of calls requested by a user, time taken by the user, etc.

To charge a fare for premium services, it is essential to manage the QoS of each premium service, to control the admission of a call, and to authenticate individual service calls.

It is necessary to approve authenticated traffic to use a network and charge a fare for the use of the network, and to prevent traffic in a network layer caused by malicious users that disregard an authentication process in a service layer to use network resources and services.

So far now, once an accessed network is authenticated, Internet cannot determine whether the traffic caused by the malicious user that disregards the authentication process at the service layer. The traffic caused by the malicious user flows the network without sanction.

For example, with respect to the VoIP service, if a caller who knows the address of a receiver attempts to call without a process of controlling the call and causes traffic, it is impossible to prevent the traffic from loading down the network. Further, it is impossible to charge a user for malicious traffic in view of services or networks.

### SUMMARY OF THE INVENTION

The present invention provides a method and apparatus for authenticating traffics based on call information obtained in a call admission process and information on the header of a packet flowing into a network so as to authenticate traffic over the network.

According to an aspect of the present invention, there is provided a traffic authentication apparatus comprising: a call admission control agent receiving a call admission request from a calling terminal; a network controller determining whether to approve the call admission request received by the call admission control agent and obtaining call information from the call admission request; and a networking unit which, when the networking unit receives traffic from the calling terminal, compares information on the header of a packet of the traffic with the call information received from the network controller and authenticates the traffic.

According to another aspect of the present invention, there is provided a traffic authentication method comprising: (a) receiving a call admission request from a calling terminal; (b) determining whether to approve the call admission request and obtaining call information from the call admission request; (c) transferring the call information to a networking unit; and (d) when the networking unit receives traffic from the calling terminal, comparing information on a header of a packet of the traffic with the call information received from the network controller and authenticating the traffic.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a traffic authentication apparatus according to an embodiment of the present invention;

FIG. 2 is a flowchart illustrating data flow between units of a traffic authentication apparatus according to an embodiment of the present invention;

FIG. 3 is a flowchart illustrating a traffic authentication method according to an embodiment of the present invention; and

FIG. 4 is a flowchart illustrating a traffic authentication method according to anther embodiment of the present invention.

### DETAILED DESCRIPTION OF THE INVENTION

The present invention will now be described more fully with reference to the accompanying drawings, in which exemplary embodiments of the invention are shown.

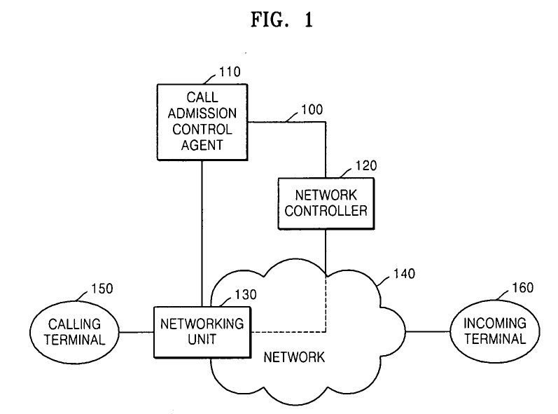

FIG. 1 illustrates a traffic authentication apparatus 100 according to an embodiment of the present invention. Referring to FIG. 1, the traffic authentication apparatus 100 comprises a call admission control agent 110, a network controller 120, and a networking unit 130.

A network 140, which is realized as an IP network, provides a premium service based on a different SLA. The networking unit 130 of the present invention is located in the network 140, which guarantees QoS and provides the premium service.

The call admission control agent 110 receives a call admission request from a calling terminal 150. The call admission control agent 110 requests the network controller 120 to perform call admission control in response to a call requested by the calling terminal 150.

The call admission control agent 110 transfers call information including the address of the calling terminal 150, the address of an incoming terminal 160, a service type, a protocol port, and QoS to the network controller 120.

The network controller 120 determines whether to approve the call admission request received by the call admission control agent 110, obtains the call information, and transfers the call information to the networking unit 130.

After finishing the call admission control, the network controller 120 controls the networking unit 130 to control traffic for the approved call.

When the networking unit 130 receives the traffic from the calling terminal 150, the networking unit 130 compares information on the header of a packet of the traffic with the call information obtained from the network controller 120, and authenticates the traffic.

If the traffic is malicious, the networking apparatus 130 blocks the malicious traffic, and processes the malicious traffic in a best effort manner or retransmits the malicious traffic to another network.

If the traffic is authentic, the traffic authentication apparatus 110 further comprises a charging unit that charges a fare for a network service provided. The fare for the network service is charged based on at least one of a class of the network service and an amount of the network service used.

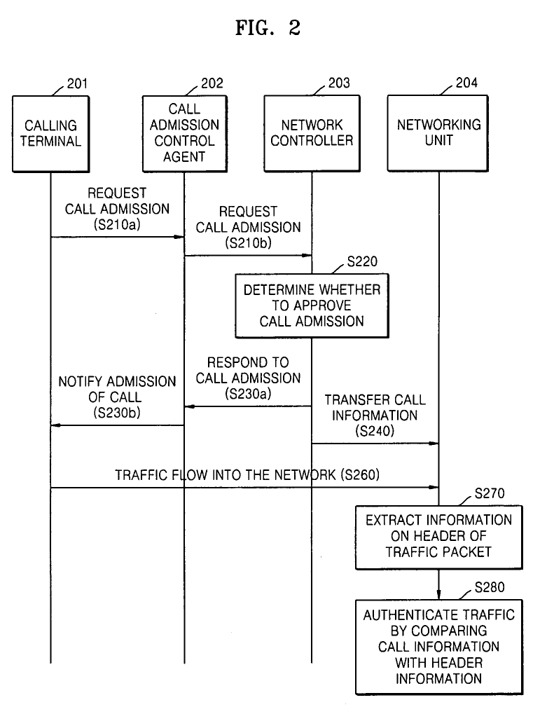

FIG. 2 is a flowchart illustrating data flow between units of a traffic authentication apparatus according to an embodiment of the present invention. Referring to FIG. 2, a calling terminal 201 requests a call admission control agent 202 for a call admission (Operation 210a).

The call admission control agent 202 requests a network controller 203 for the call admission (Operation 201b).

The network controller 203 determines whether to approve the call and transfers call information including the address of the calling terminal 201 and the address of an incoming terminal to a networking unit 204 (Operation 240).

The network controller 203 responds to the call admission control agent 202 with the call admission (Operation 230a). The call admission control agent 202 notifies the calling terminal 201 to admit a call (Operation 230b).

The network controller 203 provides an approved call with a network service. The network service is a premium service with guaranteed QoS. The present invention is particularly useful for a network providing the premium service.

A separate call admission control process and a result thereof prevent malicious traffic from flowing into the network to, which protects authentic traffic.

The network controller 203 transfers the call information obtained from the call admission control agent 202 to the networking unit 204. If the networking unit 204 receives traffic from the calling terminal 201 (Operation 260), the networking unit 204 authenticates the traffic (Operation 280).

Whether the traffic is authentic or not is determined by comparing the call information obtained by the network controller 203 with information on the header of the traffic packet flowing into the network (Operation 270).

If it is determined that the traffic is not authentic, the networking unit 204 can prevent the traffic from flowing into the network, redirect the traffic, or process the traffic in a best effort manner according to the policy of the network.

If it is determined that the traffic is authentic, the networking unit 204 can charge a fare for the network service.

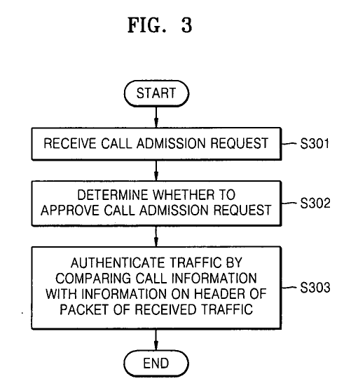

FIG. 3 is a flowchart illustrating a traffic authentication method according to an embodiment of the present invention. Referring to FIG. 3, a call admission control agent receives the call admission request from the calling terminal (Operation 301). The call admission control agent requests a network controller to control the requesting of the call admission by the calling terminal.

The network controller determines whether to approve the call admission request, and obtains call information from the call admission request (Operation 302). The call admission control agent transfers the call information including the address of the calling terminal, the address of an incoming terminal, a service type, a protocol port, and the QoS to the network controller. In detail, the network controller determines whether to approve the call admission request received from the calling terminal, obtains the call information, and transfers the call information to a networking unit.

When traffic is received from the calling terminal, the traffic is authenticated by comparing information on the header of a packet of the traffic with the call information (Operation 303).

When the traffic is received from the calling terminal, the networking unit authenticates the traffic by comparing information on the header of a packet of the traffic with the call information obtained by the call admission control agent.

Call information and the information on the header of the packet of the traffic include at least one of the calling terminal and an incoming terminal addresses, application ports, and application protocol information (service type).

If the traffic is not authentic, the networking unit blocks the traffic and processes the traffic in a best effort manner or redirects the traffic to another network. If the traffic is authentic, the networking unit can further charge a fare for a network service based on one of a class of the network service or an amount of the network service used.

The network is an IP network that provides a premium service based on a different SLA to each user. In the present invention, a network that provides a premium service with guaranteed QoS can be provided.

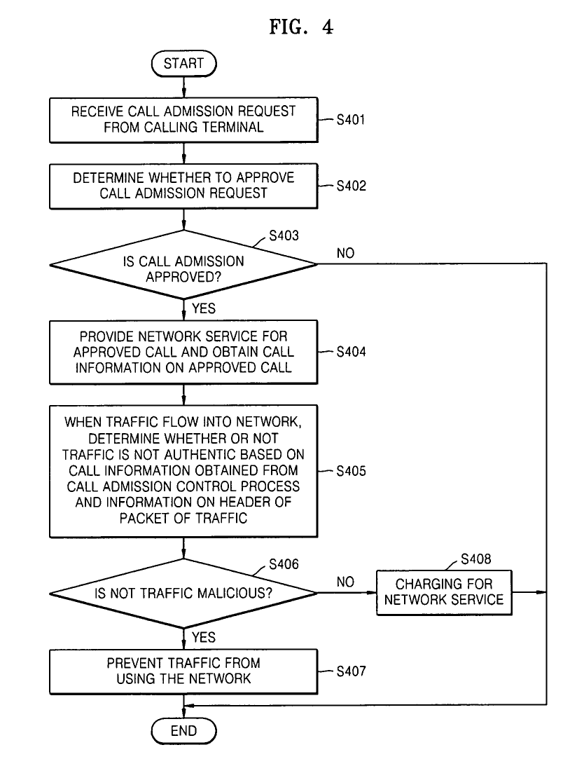

FIG. 4 is a flowchart illustrating a traffic authentication method according to anther embodiment of the present invention. Referring to FIG. 4, a call admission request is received from a calling terminal (Operation 401). It is determined whether to approve the call admission request (Operation 402).

A network service is provided to the approved call, and call information on the approved call is obtained (Operation 404). The network service is a premium service with guaranteed QoS. A fare for the network service is charged based on a class of the network service and an amount of the network service used. A call admission control process is performed through three operations 401, 402 and 404.

When the calling terminal generates traffic and sends traffic to a network, it is determined whether or not the traffic is authentic based on information on the header of a packet of the traffic and the call information on the approved call (Operation 405). It is determined by checking addresses of the calling terminal and an incoming terminal match in the call information on the approved call or the information on the header of a packet of the traffic.

If it is determined that the traffic is not authentic, the traffic is prevented from flowing into the network (Operation 407). If it is determined that the traffic is authentic, a fare for the network service is charged (Operation 408) based on the class of the network service and the amount of the network service used.

The present invention is particularly useful for networks providing premium service, and can be used to charge a user a fare based on an amount of the network service used under the management of the network.

The present invention can also be implemented as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion.

According to the present invention, service traffic generated by a user authenticated in a service layer is re-authenticated in a network layer to prevent unauthorised malicious traffic from moving to a network, thereby protecting innocent traffic and reinforcing security of the network. It is possible to control traffic of a service of which used fare can be charged, thereby increasing business profit.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A traffic authentication apparatus comprising:
a call admission control agent receiving a call admission request from a calling terminal;
a network controller determining whether to approve the call admission request received by the call admission control agent and obtaining call information from the call admission request; and
a networking unit which, when the networking unit receives traffic from the calling terminal, compares information on the header of a packet of the traffic with the call information received from the network controller and authenticates the traffic.

2. The apparatus of claim 1, further comprising: a charging unit which, if it is determined that the traffic is authentic, charges a fare for a network service.

3. The apparatus of claim 1, wherein the network service is a premium service with guaranteed QoS.

4. The apparatus of claim 2, wherein the fare for the network service is charged based on at least one of a class of the network service and an amount of the network service used.

5. The apparatus of claim 1, wherein call information on the approved call and the information on the header of the packet of the traffic include at least one of addresses, application ports and application protocol information.

6. The apparatus of claim 1, wherein if it is determined that the traffic is not authentic, the networking unit blocks the traffic to process the traffic in a best effort manner or redirects the traffic to another network.

7. A traffic authentication method comprising:
(a) receiving a call admission request from a calling terminal;
(b) determining whether to approve the call admission request and obtaining call information from the call admission request;
(c) transferring the call information to a networking unit; and
(d) when the networking unit receives traffic from the calling terminal, comparing information on a header of a packet of the traffic with the call information received from the network controller and authenticating the traffic.

8. A computer readable recording medium storing a program for executing the method of claim 7.
